(19) United States
(12) Patent Application Publication
(10) Pub. No.: US 2021/0081005 A1
(43) Pub. Date: Mar. 18, 2021

(54) HINGE MODULE AND PORTABLE ELECTRONIC DEVICE

(71) Applicant: Acer Incorporated, New Taipei City (TW)

(72) Inventors: Yi-Ta Huang, New Taipei City (TW); Cheng-Nan Ling, New Taipei City (TW); Wen-Chieh Tai, New Taipei City (TW); Wu-Chen Lee, New Taipei City (TW); Kun-You Chuang, New Taipei City (TW)

(73) Assignee: Acer Incorporated, New Taipei City (TW)

(21) Appl. No.: 16/799,852

(22) Filed: Feb. 25, 2020

(30) Foreign Application Priority Data
Sep. 17, 2019 (TW) 108133419

(51) Int. Cl. G06F 1/16

(52) U.S. Cl. CPC G06F 1/1681; G06F 1/1618

(57) ABSTRACT

A hinge module including a first bracket, a linking rod, and a second bracket. A first rotating shaft is disposed on the first bracket. The linking rod has a first end and a second end opposite to each other. The first end is pivoted to the first rotating shaft. A second rotating shaft is disposed on the second bracket and movably and pivotably connected to the first bracket. The second end of the linking rod is pivoted to the second bracket. In a process where the first bracket and the second bracket are rotated relatively, the first rotating shaft and the second rotating shaft are moved close to or away from each other. A portable electronic device is also disclosed.

### CROSS-REFERENCE TO RELATED APPLICATION

This application claims the priority benefit of Taiwan application serial no. 108133419, filed on Sep. 17, 2019. The entirety of the above-mentioned patent application is hereby incorporated by reference herein and made a part of this specification.

### BACKGROUND

### Technical Field

The disclosure relates to a hinge module and a portable electronic device.

### Description of Related Art

Portable computing devices, such as palmtop computers, portable computers, notebook computers, and personal digital assistants (PDAs) have become more and more popular. In general, a portable electronic device includes a base and a display assembly configured for the display of the base to comply with user operation and viewing purposes. In particular, as touch display technology advances through time, for portable computers, touch screens have gradually become the basic equipment.

In general, to provide the user with a favorable visual effect as well as designing notebook computers to be lighter, thinner, more compact, and smaller, pursuing a higher screen-to-body ratio or a slim bezel has now become the trend in notebook computer design. Accordingly, the hinge of notebook computers needs to adopt a sunken design to cope with such needs. In other words, the hinge is designed to generate a motion of moving downward relative to the device body while simultaneously rotating the device body as well as moving the screen toward the device body where the system is located.

However, limited by the rotating radius of the hinge, if the above needs are to be coped with, interference between device bodies may easily occur during the rotating process, making it difficult to achieve a favorable effect.

### SUMMARY

Embodiments of the disclosure provide a hinge module and a portable electronic device having a flexible hinge so that device bodies of the portable electronic device are relatively movable during a rotating process.

A hinge module according to an embodiment of the disclosure includes a first bracket, a first rotating shaft, a connecting rod, a second bracket, and a second rotating shaft. The first rotating shaft is disposed on the first bracket. The linking rod has a first end and a second end opposite to each other. The first end is pivoted to the first rotating shaft. A second rotating shaft is disposed on the second bracket and movably and pivotably connected to the first bracket. The second end of the linking rod is pivoted to the second bracket. In a process where the first bracket and the second bracket are rotated relatively, the first rotating shaft and the second rotating shaft are moved close to or away from each other.

A portable electronic device according to an embodiment of the disclosure includes a first device body, a first rotating shaft, a second device body, a second rotating shaft, a first bracket, a second bracket, and a connecting rod. The first rotating shaft is disposed on the first bracket. The linking rod has a first end and a second end opposite to each other. The first end is pivoted to the first rotating shaft. A second rotating shaft is disposed on the second bracket and movably and pivotably connected to the first bracket. The second end of the linking rod is pivoted to the second bracket. In a process where the first device body and the second device body are rotated relatively, the first bracket and the second bracket are rotated relatively following the first device body and the second device body, and the first rotating shaft and the second rotating shaft are moved close to or away from each other.

Based on the above, by disposing the hinge structure in the portable electronic device, the first device body and the second device body can be moved close to or away from each other through the corresponding relationship among the first rotating shaft, the second rotating shaft, and the linking rod of the hinge module when the first device body and the second device body are rotated relatively. In other words, the hinge module forms a configuration similar to a linkage mechanism. In this way, the second rotating shaft can be moved close to or away from the first rotating shaft when the second bracket is rotated relative to the first bracket. Accordingly, in the process where the first device body is rotated relative to the second device body to be opened or closed, the mechanical interference between the device bodies due to limitation of a fixed-type hinge or a fixed distance between rotating shafts can be avoided, and the device bodies can be opened or closed smoothly through rotation.

To make the above features and advantages of the disclosure more comprehensible, embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view illustrating a portable electronic device according to an embodiment of the disclosure.

FIGS. 2A and 2B are schematic views illustrating a hinge module of FIG. 1 from different viewing angles.

FIGS. 3A and 3B are exploded views illustrating a hinge module from different viewing angles.

FIGS. 4A to 4D are side views illustrating a hinge module in different states.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

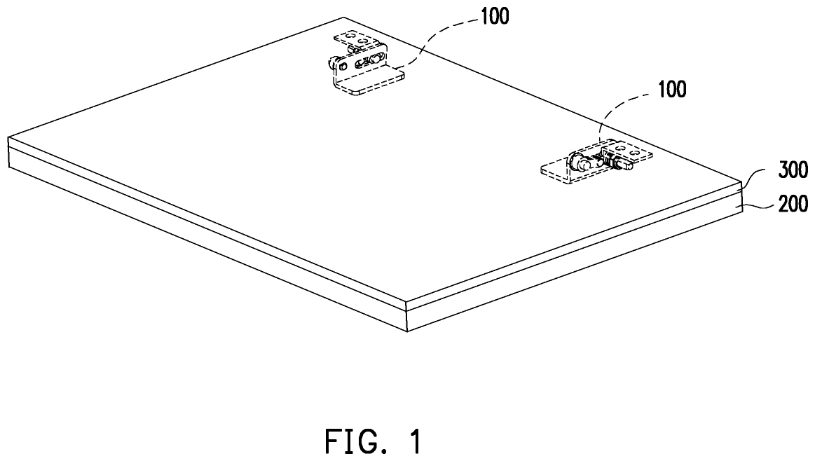

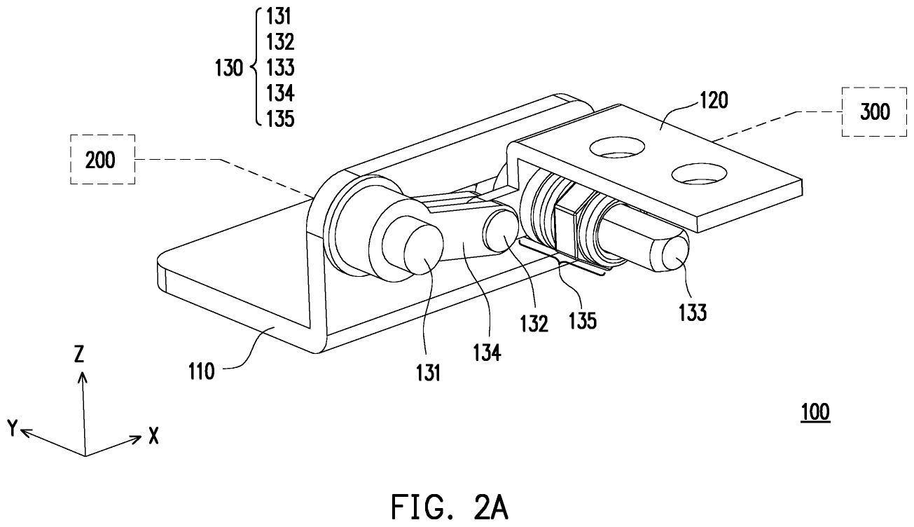

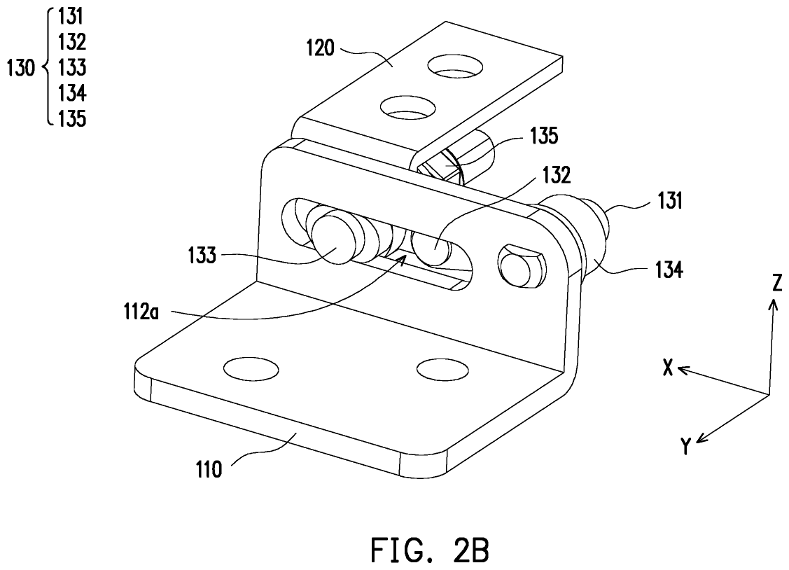

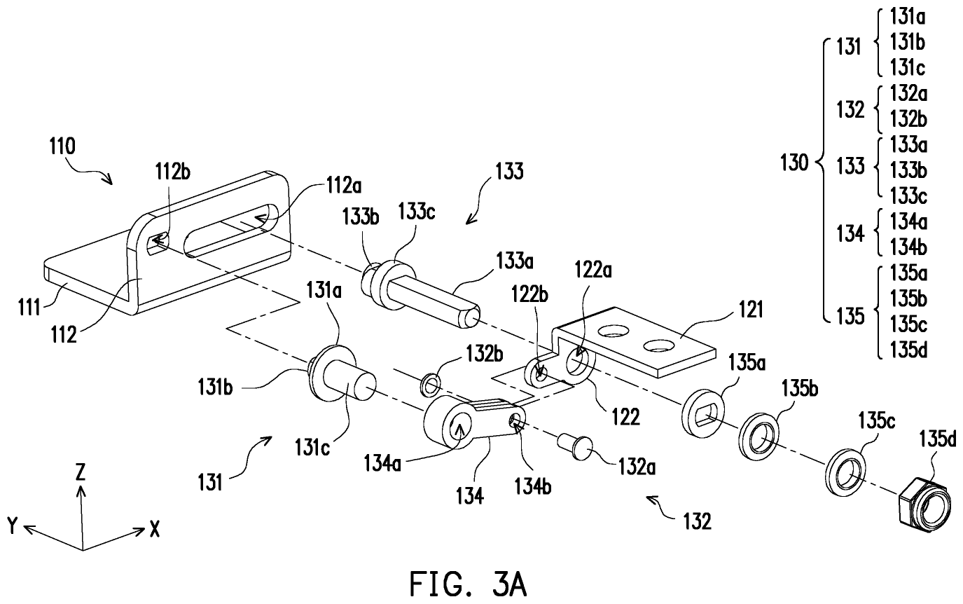

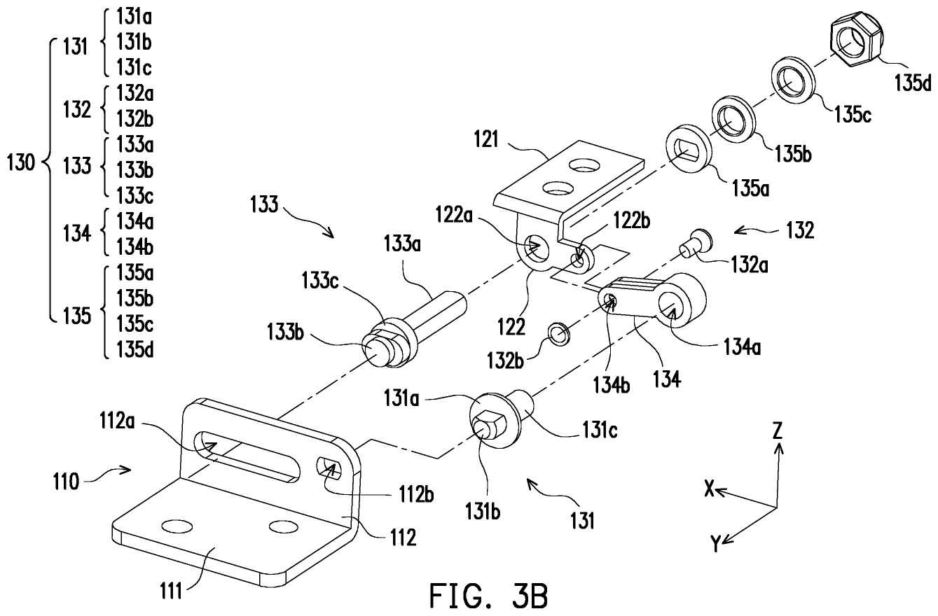

FIG. 1 is a schematic view illustrating a portable electronic device according to an embodiment of the disclosure. FIGS. 2A and 2B are schematic views illustrating a hinge module of FIG. 1 from different viewing angles. Here, a Cartesian (X-Y-Z) coordinate system is provided to more easily describe the components. Referring to FIGS. 1, 2A, and 2B, in the embodiment, a portable electronic device 10 includes a first device body 200, a second device body 300, and a hinge module 100 connected with the first device body 200 and the second device body 300. The first device body 200 and the second device body 300 are relatively rotatable with each other through the hinge module 100 to be opened or closed. The hinge module 100 includes a first bracket 110, a second bracket 120, a first rotating shaft 131, a second rotating shaft 133, and a linking rod 134. The first rotating shaft 131 is disposed on the first bracket 110, the second rotating shaft 133 is disposed on the second bracket 120, the first bracket 110 is assembled to the first device body 200, and the second bracket 120 is assembled to the second device body 300.

FIGS. 2A and 2B are schematic views illustrating a hinge module of FIG. 1 from different viewing angles. Referring to FIGS. 2A and 2B, in the embodiment, the first bracket 110 includes a bottom plate 111 and a standing plate 112. The bottom plate 111 is located on the X-Y plane and assembled to the first device body 200, and the standing plate 112 is located on the X-Z plane and has a track 112a and a positioning hole 112b. The first rotating shaft 131 has a positioning part 131b, a pressing part 131a, and a shaft part 131c. The positioning part 131b is engaged with the positioning hole 112b and positioned on the X-Z plane, and the first rotating shaft 131 abuts against the standing plate 112 along Y-axis through the pressing part 131a being pressed against the standing plate 112. The linking rod 134 includes a first end 134a and a second end 134b which are opposite to each other and respectively pivot holes. The first end 134a is pivoted to the shaft part 131c of the first rotating shaft 131.

The second racket 120 includes a bottom plate 121 and an extending part 122 standing below the bottom plate 121. A pivot hole 122b and a shaft hole 122a are disposed on the extending part 122. The second rotating shaft 133 has a moving part 133b, a pressing part 133c, and a shaft part 133a. The shaft part 133a penetrates through the shaft hole 122a. In addition, in the embodiment, the extending part 122 is considered as being located on the X-Z plane, and the shaft direction (Y-axis direction) of the second rotating shaft 133 is orthogonal to the X-Z plane.

Moreover, the moving part 133b is movably and pivotably coupled to the track 112a of the first bracket 110, and the pressing part 133c abuts against the standing plate 112 of the first bracket 110 along Y-axis. At the second end 134b, the linking rod 134 is arranged as a coupling structure and pivoted to the pivot hole 122b of the extending part 122 through a connecting assembly 132 (including components 132a and 132b riveted to each other). In addition, the extending part 122 is substantially pivotably sandwiched in the coupling structure.

Moreover, the hinge module 100 further includes a torque assembly 135 including a pressing member 135a, torque members 135b and 135c, and a locking member 135d. After the shaft part 133a of the second rotating shaft 133 penetrates through the shaft hole 122a, the pressing member 135a, the torque members 135b and 135c, and the locking member 135d are sequentially disposed on the shaft part 133a of the second rotating shaft 133 and abut against the extending part 122 of the second bracket 120. Accordingly, a torque force is provided between the second bracket 120 and the second rotating shaft 133 by the torque assembly 134 through the friction force which the torque assembly 135 can generate when the second bracket 120 and the second rotating shaft 133 are relatively pivotally rotated on Y-axis.

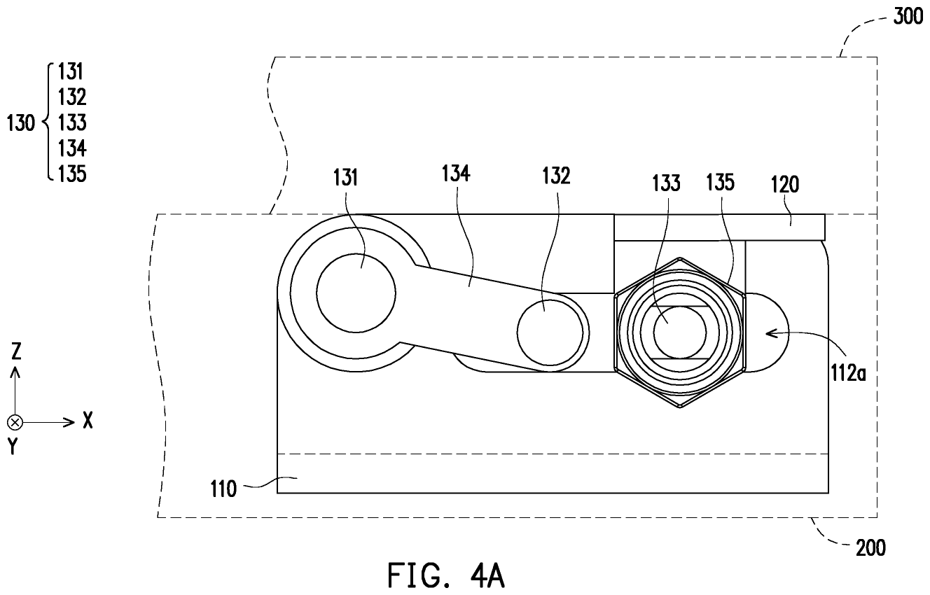

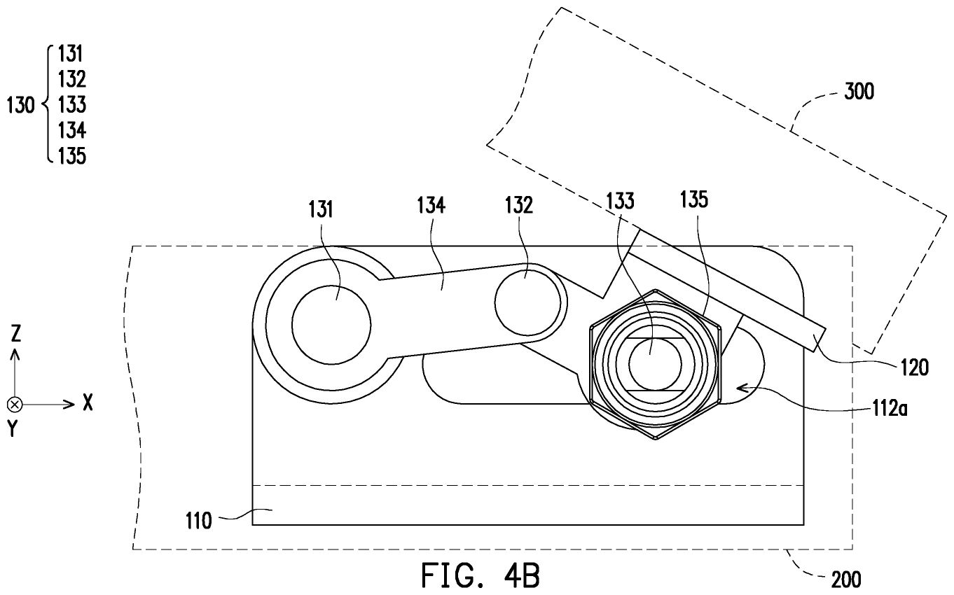

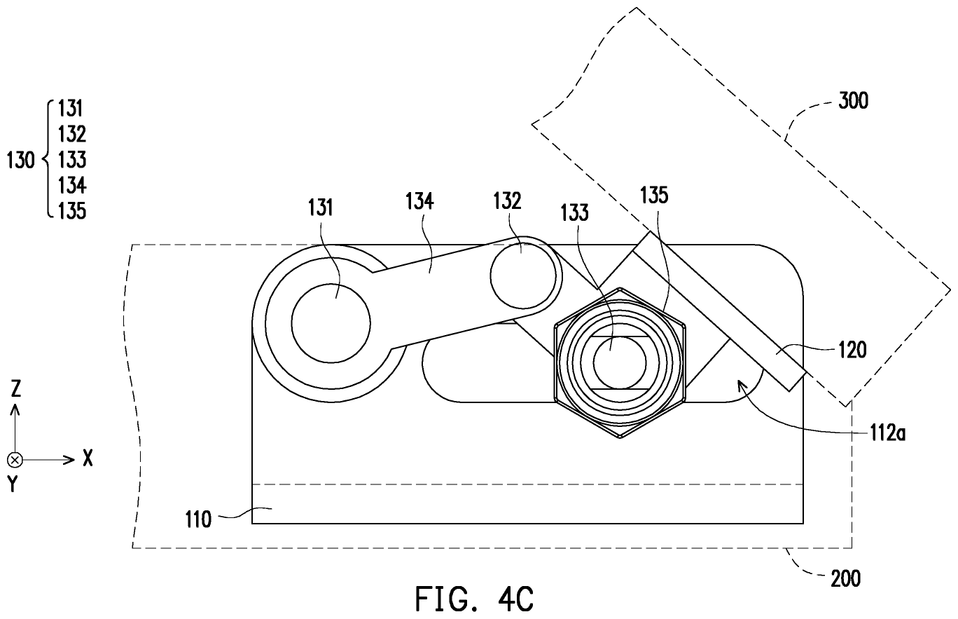

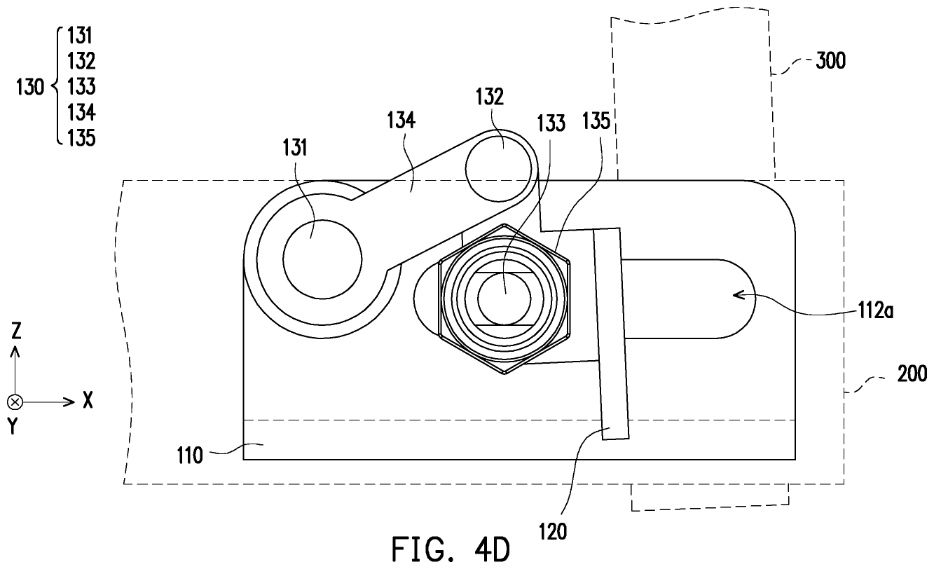

FIGS. 4A to 4D are side views illustrating a hinge module in different states.

Referring to FIG. 4A, based on the configuration above, the first rotating shaft 131, the second rotating shaft 133, the connecting assembly 132, the linking rod 134, and the torque assembly 135 of the embodiment form a torque linkage mechanism 130. Since the shaft direction of the first rotating shaft 131 and the shaft direction of the second rotating shaft 133 are parallel to each other, the torque linkage mechanism 130 substantially carries out a linkage movement on the same plane (X-Z plane), as shown in FIG. 4A. Here, like the illustration of FIG. 1, FIG. 4A shows a state where the first device body 200 and the second device body 300 are folded and closed with respect to each other. In the state, the distance between the second rotating shaft 133 and the first rotating shaft 131 has the maximum value.

Then, referring to FIGS. 4B to 4D, the first device body 200 is pivotally rotated and expanded relative to the second device body 300. In other words, the second device body 300 is rotated in the clockwise direction with the first device body 200 serving as the reference. At this time, due to the connection relationship among the components of the torque linkage mechanism 130, the first rotating shaft 131 is rotated in the counter-clockwise direction, the second rotating shaft 133 is rotated in the clockwise direction, and the linking rod 134 is rotated in the counter-clockwise direction while simultaneously driving the second rotating shaft 133 to slide along the track 112a toward the negative X-axis direction, so as to gradually move toward the first rotating shaft 131 located at one end of the track 112a until the second rotating shaft 133 is close to the first rotating shaft 131 and the distance therebetween has the minimum value, as shown in FIG. 4D.

Comparatively, when the first device body 200 and the second device body 300 are relatively rotated and closed from the expanded state shown in FIG. 4D, the state is sequentially changed from the state shown in FIG. 4D to the state shown in FIG. 4A. That is, the second rotating shaft 133 is moved toward the positive X-axis direction along the track 112a due to the rotation of the second bracket 120, so as to move away from the first rotating shaft 131 until the second rotating shaft 133 is restored to the position shown in FIG. 4A.

In view of the foregoing, in the embodiment of the disclosure, by disposing the hinge structure in the portable electronic device, the first device body and the second device body can be moved close to or away from each other through the corresponding relationship among the first rotating shaft, the second rotating shaft, and the linking rod of the hinge module when the first device body and the second device body are rotated relatively. In other words, the hinge module forms a configuration similar to a linkage mechanism. In this way, the second rotating shaft can be moved close to or away from the first rotating shaft when the second bracket is rotated relative to the first bracket. Accordingly, in the process where the first device body is rotated relative to the second device body to be opened or closed, the mechanical interference between the device bodies due to limitation of a fixed-type hinge or a fixed distance between rotating shafts can be avoided, and the device bodies can be opened or closed smoothly through rotation.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A hinge module, adapted for a portable electronic device, the hinge module comprising:
a first bracket;
a first rotating shaft, disposed on the first bracket;
a linking rod, having a first end and a second end opposite to each other, wherein the first end is pivoted to the first rotating shaft;
a second bracket; and
a second rotating shaft, disposed on the second bracket, wherein the second rotating shaft is movably and pivotably connected to the first bracket, the second end of the linking rod is pivoted to the second bracket, and in a process where the first bracket and the second bracket are rotated relatively, the first rotating shaft and the second rotating shaft are moved close to or away from each other.

2. The hinge module as claimed in claim 1, wherein the first bracket further comprises a track, the second rotating shaft is movably and pivotably coupled to the track, the first rotating shaft is adjacent to an end of the track, and the second rotating shaft is moved close to or away from the first rotating shaft along the track.

3. The hinge module as claimed in claim 1, wherein the second bracket has an extending part, the second rotating shaft penetrates through the extending part, and a shaft direction of the second rotating shaft is orthogonal to a plane where the extending part is located.

4. The hinge module as claimed in claim 3, wherein the linking rod is arranged as a coupling structure at the second end, and the extending part is pivotably engaged in the coupling structure.

5. The hinge module as claimed in claim 1, wherein a shaft direction of the first rotating shaft is parallel to a shaft direction of the second rotating shaft.

6. The hinge module as claimed in claim 1, further comprising a torque assembly disposed on the second rotating shaft and pressed against the second bracket.

7. The hinge module as claimed in claim 1, wherein a rotating direction of the first rotating shaft is opposite to a rotating direction of the second rotating shaft.

8. A portable electronic device, comprising:
a first device body;
a first bracket, assembled to the first device body;
a first rotating shaft, disposed on the first bracket;
a linking rod, having a first end and a second end opposite to each other, wherein the first end is pivoted to the first rotating shaft;
a second device body; and
a second bracket, assembled to the second device body;
a second rotating shaft, disposed on the second bracket, wherein the second rotating shaft is movably and pivotably connected to the first bracket, the second end of the linking rod is pivoted to the second bracket, and in a process where the first device body and the second device body are rotated relatively, the first bracket and the second bracket are rotated relatively following the first device body and the second device body, and the first rotating shaft and the second rotating shaft are moved close to or away from each other.

9. The portable electronic device as claimed in claim 8, wherein the first bracket further comprises a track, the second rotating shaft is pivotably coupled to the track, the first rotating shaft is adjacent to an end of the track, and the second rotating shaft is moved close to or away from the first rotating shaft along the track.

10. The portable electronic device as claimed in claim 8, wherein the second bracket has an extending part, the second rotating shaft penetrates through the extending part, and a shaft direction of the second rotating shaft is orthogonal to a plane where the extending part is located.

11. The portable electronic device as claimed in claim 10, wherein the linking rod is arranged as a coupling structure at the second end, and the extending part is pivotably engaged in the coupling structure.

12. The portable electronic device as claimed in claim 8, wherein a shaft direction of the first rotating shaft is parallel to a shaft direction of the second rotating shaft.

13. The portable electronic device as claimed in claim 8, further comprising a torque assembly disposed on the second rotating shaft.

14. The portable electronic device as claimed in claim 8, wherein a rotating direction of the first rotating shaft is opposite to a rotating direction of the second rotating shaft.

15. The portable electronic device as claimed in claim 8, wherein when the first device body and the second device body are folded and closed with respect to each other, a distance between the first rotating shaft and the second rotating shaft has a maximum value, and in a process where the first device body and the second device body are expanded with respect to each other, the second rotating shaft is moved to the first rotating shaft.
